(19) United States
(12) Patent Application Publication
(10) Pub. No.: US 2007/0180353 A1
(43) Pub. Date: Aug. 2, 2007

(54) Systems and methods for generating documents using multimedia data gathering tools

(75) Inventor: Allan Hundhausen, Laguna Beach, CA (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Quark, Inc., Denver, CO (US)

(21) Appl. No.: 11/335,243

(22) Filed: Jan. 18, 2006

(51) Int. Cl. G06F 17/00

(52) U.S. Cl. 715/500; 715/507; 715/526

(57) ABSTRACT

A system for generating a document by collecting information from an end user using a multimedia interface using at least one computing system comprising a processor and a computer readable medium. The computer readable medium has instructions executable by the processor to receive instructions to create a print document template, which includes a variety of fields to be populated by data received from an end user. The computer readable medium also receives instructions to create an interactive application, which is operable to solicit and receive data from the end user, and the data being mapable to the various field of the print document template. The processor forwards the interactive application to the end user and receives data from the end user through the interactive application and formats the print document template with the data received from the end user.

### CROSS REFERENCE TO RELATED APPLICATIONS

The present application is related to U.S. patent application Ser. No. ______ (Attorney Docket No. 56578-314062) entitled “Systems and Methods for Remote Access Media Production,” filed by Hundhausen et al.; and U.S. patent application Ser. No. ______ (Attorney Docket No. 56578-308707) entitled “Systems and Methods for Developing Dynamic Media Productions,” filed by Hundhausen et al. Each of the aforementioned applications is assigned to an entity common hereto, and filed on a date common herewith. The entirety of each of the aforementioned applications is incorporated herein by reference for all purposes.

### BACKGROUND OF THE INVENTION

The present invention relates generally to systems and methods for producing forms and other documents, and more particularly to systems and methods for populating forms and documents with data collected from end users using an interactive interface.

Paper-based work flows, such as insurance applications, mortgage applications, tax forms, etc. are becoming more and more automated as ePaper-type form applications are replacing paper forms. With ePaper forms, users typically must fill-out the forms electronically, either locally or remotely (e.g., via some form of network connection). The problem with ePaper-type forms (e.g., PDF forms, Microsoft word forms, etc.) is that they do not have user friendly interfaces, such as prompts, wizard interfaces, or help information, to help fill-out fields, and they have very limited field calculation capabilities.

Rich user interfaces (i.e., rich Internet applications), however, can facilitate data gathering from end users by providing them with wizard functionality, help interfaces, prompts, auto-fill features, automatic field calculation features, and other interactive features. Unfortunately, these rich user interfaces cannot generate high fidelity or rich output formats, such as PDF or other high end print formats.

Thus, a need exists for a robust content authoring system and process for integrating these two worlds, so that end users can interact with compelling, rich user interfaces, and afterwards can generate rich output formats with the data obtained from the interactive user interfaces.

### BRIEF SUMMARY OF THE INVENTION

In one embodiment, the present invention relates to a method for generating a document by collecting information from an end user using a multimedia interface. In accordance with this embodiment of the invention, the method comprises creating a print document template, which includes a plurality of fields to be populated by data received from an end user. The method further comprises creating an interactive application, which can be operable to solicit and receive data from the end user. In accordance with this aspect of the invention, the data received via the interactive application is mapable to the plurality of fields of the print document template. After the print document template and the interactive application are created, the method comprises forwarding the interactive application to the end user, receiving data from the end user via the interactive application, and formatting the print document template with the data received from the end user.

In accordance with another embodiment of the invention, the method further comprises forwarding the print document template to the end user for printing. Further, in some embodiments, the interactive application can be any suitable interactive-type application that can be run on an end user computer system, such as, a flash application, a java applet, a extensible application mark-up language (XAML) application, a scalable vector graphics (SVG) application, or the like. In addition, the print document template can be comprise any suitable print document format, such as, a Microsoft™ Word™ document, an Adobe™ Portable Document Format (PDF) document, a postscript formatted document, a SVG print document, or the like.

In accordance with some embodiments of the invention, forwarding the interactive application to the end user can include forwarding the entire interactive application to the end user prior to the end user running the interactive application. Alternatively, in other embodiments, forwarding the interactive application to the end user can include an end user computer pulling at least some of the interactive application instructions from a server computer upon which the interactive application resides. In still other embodiments of the invention, the data received from the end user via the interactive application comprises data in extensible mark-up language (XML) format.

In still other embodiments of the invention, the method can be performed on one or more computing systems. In one embodiment, all steps are performed on a single computing system. In another embodiment, the steps of creating a print document template and creating an interactive application can be performed by a first computing system, and the steps of forwarding the interactive application to the end user, receiving data from the end user via the interactive application, and formatting the print document template with the data received from the end user can be performed by a second computing system. Finally, in still other embodiments, a plurality of networked computers can perform the methods of the present invention.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram showing one embodiment of a computer system that can generate document and application templates;

FIG. 2 is a screen shot illustrating one embodiment of an application that can generate a print document template;

FIG. 3 is a screen shot illustrating one embodiment of an application that can generate an interactive application program;

FIG. 4 is a diagram illustrating one embodiment of how fields from a document template can be mapped with fields associated with an interactive application;

FIG. 5 is a screen shot illustrating one embodiment of how an interactive application can be formatted and saved into a specific application format;

FIG. 6 is a block diagram illustrating one embodiment of how an interactive application can be transmitted to an end user;

FIG. 7 is a block diagram illustrating one embodiment of an interactive application being displayed on an user's monitor;

FIG. 8 is a screen shot illustrating one embodiment of an interactive application as seen by an end user;

FIG. 9 is a block diagram illustrating one embodiment of how information that an end user entered into an interactive application can be sent to a server;

FIG. 10 is a block diagram showing one embodiment of information that an end user entered into a interactive application being applied to a document template;

FIG. 11 is a diagram illustrating a final document being transmitted to an end user;

FIG. 12 is a screen shot of a document populated with information enter by an end user via an interactive application; and

FIG. 13 is a block diagram showing a final document being printed by an end user.

### DETAILED DESCRIPTION OF THE INVENTION

The present invention relates generally to systems and methods for producing forms and other documents, and more particularly to systems and methods for populating forms and documents with data collected from end users using an interactive interface. As discussed in more detail below, the forms, documents and applications discussed herein can be created using Quark Inc.'s desktop application (QuarkXpress™) and/or server-based application (QuarkDDS™). Various versions of QuarkXpress and QuarkDDS that can be used to generate forms, documents, web pages, interactive applications, etc. are currently known in the art. In addition, other novel features, enhancements, and applications that can be used to create and/or generate forms, documents, web pages, applications (including interactive applications), etc. are disclosed in the following U.S. patent applications: U.S. patent application Ser. No. 10/980,416 filed on Nov. 2, 2004 by Varela et al., and entitled “Systems and Methods for Producing Media Products;” U.S. patent application Ser. No. 10/980,424 filed on Nov. 2, 2004 by Allen et al., and entitled “Systems and Methods for Distributing Media Production;” U.S. patent application Ser. No. 10/980,405 filed on Nov. 2, 2004 by Allen et al., and entitled “Systems and Methods for Facilitating Media Production;” U.S. patent application Ser. No. 10/980,415 filed on Nov. 2, 2004 by Wadsworth et al., and entitled “Systems and Methods for Re-Purposing Content Objects for Media Production;” and U.S. patent application Ser. No. 10/980,416 filed on Nov. 2, 2004 by Varela et al., and entitled “Systems and Methods Multi-Format Media Production;” U.S. patent application Ser. No. 10/063,317 filed on Apr. 10, 2002 by Hundhausen et al., and entitled “Systems and Process for Dynamic Document Production;” U.S. patent application Ser. No. ______ filed on ______ by Hundhausen et al., and entitled “Systems and Methods for Remote Access Media Production (Attorney Docket No. 56578-314062);” and U.S. patent application Ser. No. ______ filed on ______ by Hundhausen et al., and entitled “Systems and Methods for Developing Dynamic Media Productions (Attorney Docket No. 56578-308707).” All of the aforementioned applications are incorporated herein by reference for all purposes, and collectively are referred to herein as the “Incorporated References.”

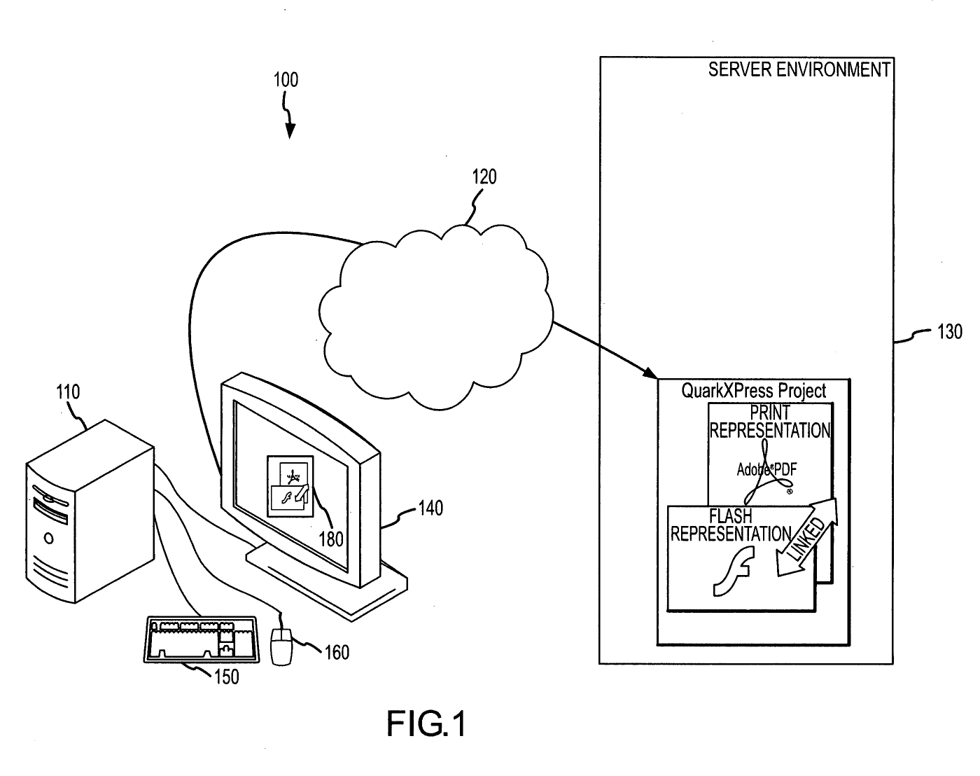

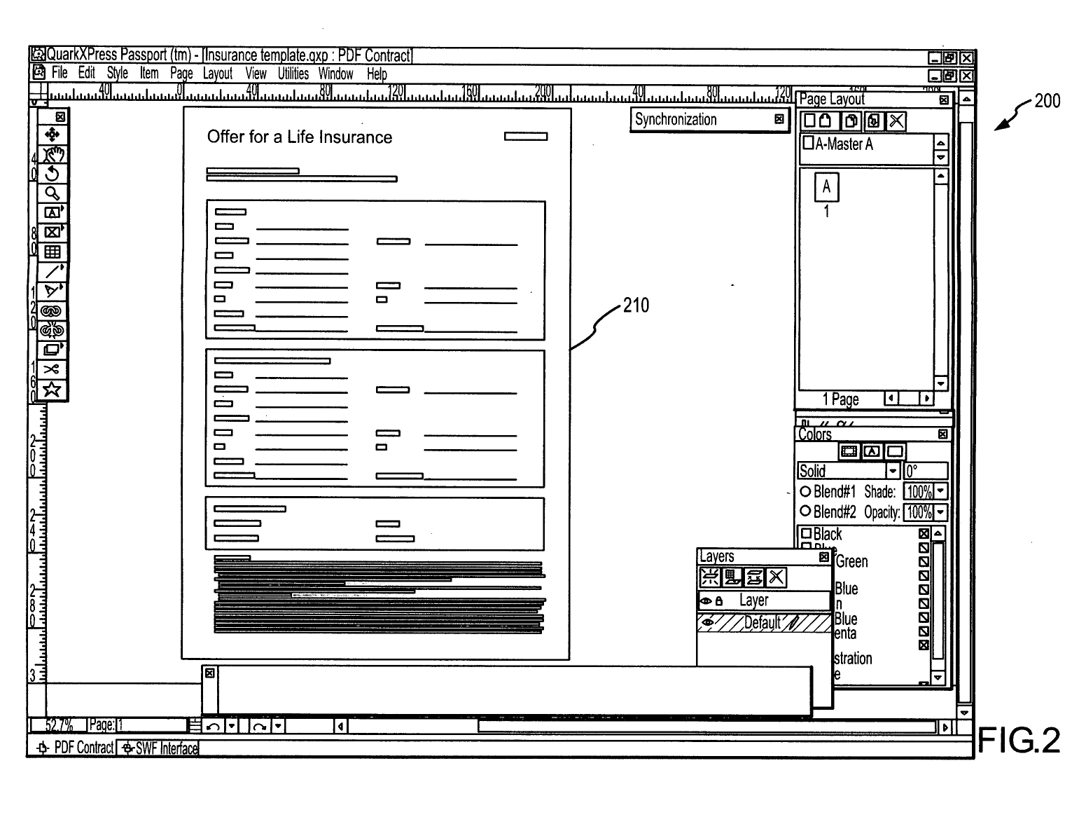

Referring now to FIG. 1, a block diagram illustrating one embodiment of a computer system 100 that can be used to generate and make available document and application templates is shown. In accordance with one embodiment of the invention, computer system 100 comprises at least one computer 110, a communication connection 120 for communicating information, and a server environment 130. Computer 110 can be any suitable computing device, such as a personal computer, a workstation computer, or any other suitable computing device. As one skilled in the art will appreciate, computer 110 can include a processor, memory, and static storage, such as a read only memory (ROM) and/or other static storage device(s) for storing static information and instructions for processing.

In addition, computer 110 can include a data storage device, such as a magnetic disk drive, an optical disc drive, a flash memory device, or the like for storing information and instructions. Computer 110 also can be coupled (e.g., via a bus) to a display device 140 (e.g., a cathode ray tube (CRT), a Liquid Crystal Display (LCD), a plasma display, or the like) for displaying information to a computer user. For example, graphical depictions of document generation tools, application templates, and other types of information may be presented to the user on the display device. Further, computer 110 typically can include an alphanumeric input device 150, including alphanumeric and other keys, for communicating information and/or command selections to the processor, and a cursor control device 160, such as a mouse, a trackball, or cursor direction keys for communicating direction information and command selections to the processor and for controlling cursor movement on the display.

Computer 110 also can include a communication device for accessing other devices, such as a remote server via a network infrastructure 170, for example, an intranet, the Internet, or any other suitable network infrastructure. The communication device may include a modem, a network interface card, or other well known interface devices, such as those used for coupling to an Ethernet, token ring, wireless, or other types of networks. In any event, in this manner, computer 110 may be coupled to a number of clients and/or servers via a network infrastructure, such as a company's intranet and/or the Internet, for example.

In accordance with the illustrated embodiment, computer system 100 is operable for an end user to generate document and/or application templates 180 that, for example, can be stored on a server in the server environment 130. In this regard, computer 110 hosts a software program capable of creating an interactive application, which can be operable to solicit and receive data from an end user. Examples of software applications that can be used to create forms, documents, templates, applications, etc. include, but are not limited to QuarkXPress, QuarkDDS, and any or all of the novel features, functions and applications disclosed in the Incorporated References disclosed above.

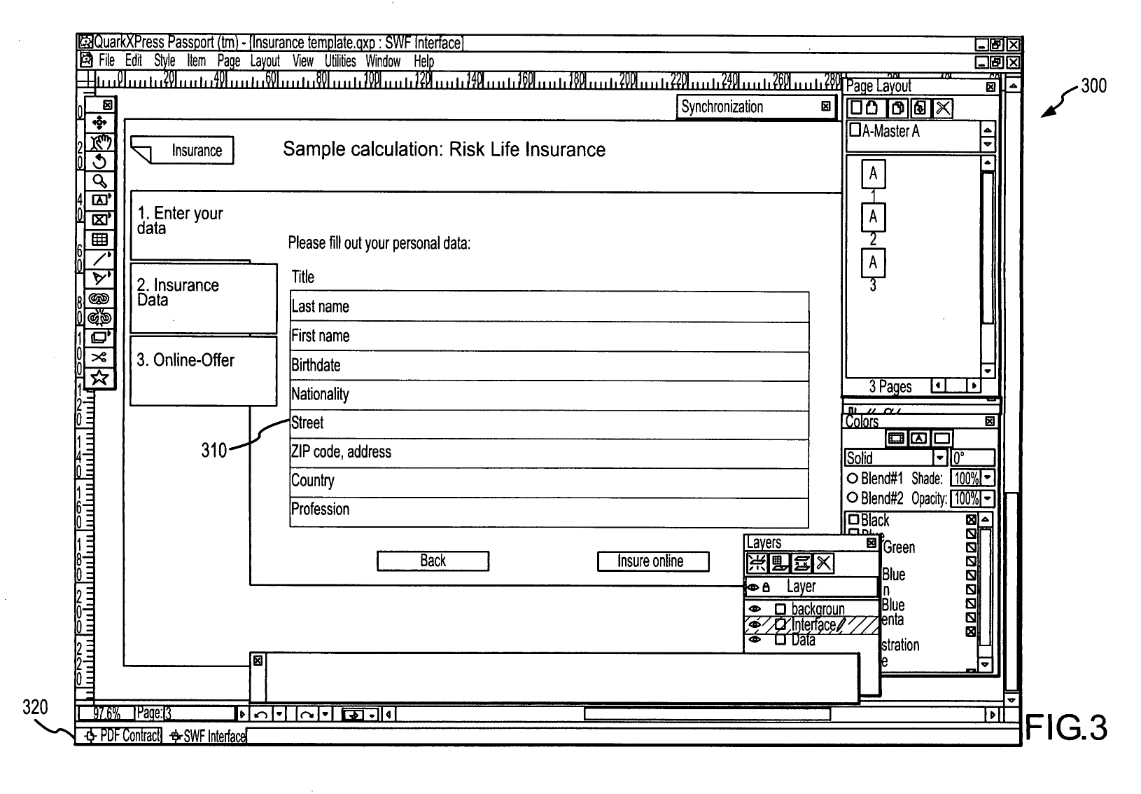

Referring now to FIG. 2, a screen shot illustrating one embodiment of an application 200 that can generate a print document template 210 is shown. In the illustrated embodiment, application 200 used to create the print document template 210 is QuarkXpress, as discussed above. The print document template created by application 200 can be any suitable print document format, such as, for example, a QuarkXpress document or template, a Microsoft™ Word™ document, an Adobe™ Portable Document Format (PDF) document, a postscript formatted document, a SVG print document, or the like. In some embodiments, the QuarkXpress application can generate documents in any or all the aforementioned formats.

Various tools are available within the application to assist the designer in creating the print document template. Examples include, but are not limited to, common functionality, such as rotating, cropping, cutting, pasting, creating tables, creating boxes, creating lines, creating fields, creating other common shapes, etc. Other examples of common functionality include selecting and associating fonts and colors with various parts of the design. Some aspects of document generation are will known in the art. In addition, other novel aspects of document generation and disclosed and claimed in the Incorporated References disclosed above.

In accordance with one embodiment of the invention, application 200 is operable to create a print document template 210, which includes one or more fields to be populated by data received from an end user. Various embodiments of the present invention include an interactive application 310 (see FIG. 3) that allows an end user to interactively enter data that will be used to populate the one or more of fields in print document template 210.

In accordance with various embodiment of the invention, interactive application 310 can be any suitable interactive-type application that can be run on an end user computer system, such as, a Shockwave™ flash application, a java applet, a extensible application mark-up language (XAML) application, a scalable vector graphics (SVG) application, or the like. In some embodiments, some or all of the interactive application can be uploaded to the end user computer for processing. Alternatively, the interactive application might be hosted on a server computer and accessed remotely by the end user computers. As one skilled in the art will appreciate, the present invention is not limited to any particular method in which the end user computer accesses the interactive application.

Referring now to FIG. 3, a screen shot illustrating one embodiment of an application 300 that can be used to generate an interactive application 310 is shown. In the embodiments illustrated in FIG. 2 and FIG. 3, the same application is capable of creating the print document template and the interactive multimedia application interface. The benefit of using one application to generate both the print document and the interactive application is that the application than can easily relate the print document to the interactive application. That is, the common application can relate or map the data received via interactive application 310 to the plurality of fields in the print document template 210. This allows the user to interactively enter data that will be used to complete the print document template (e.g. a form, an application, etc.). In this particular embodiment, QuarkXpress is the application used to create both the print document template and the interactive application. In the illustrated embodiment, indexing tabs 320 allow a designer to go back and forth between the screen for creating the print document template and the screen for creating the interactive multimedia application.

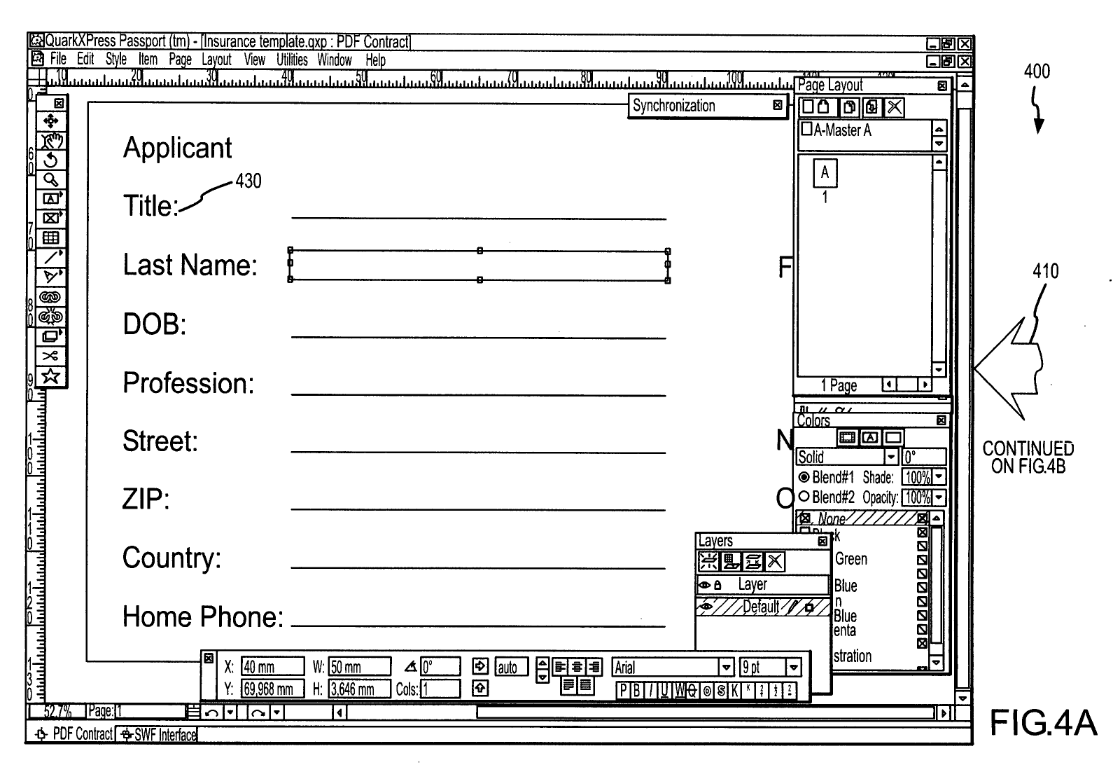

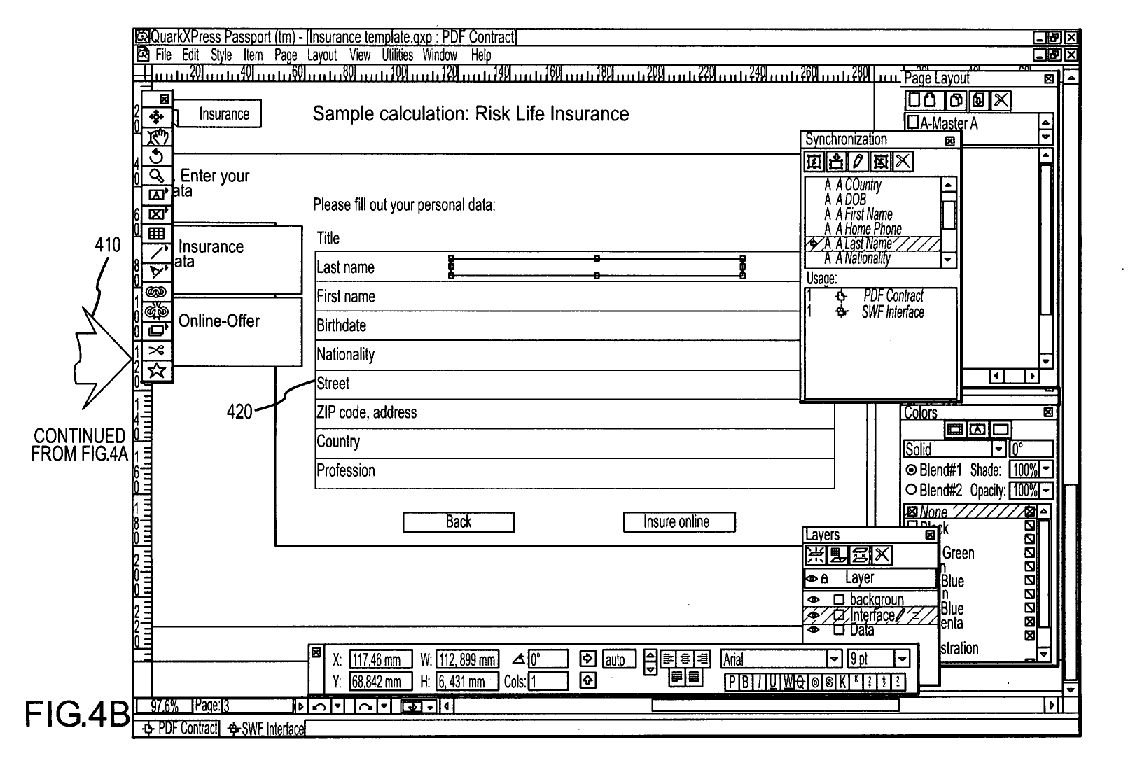

Referring now to FIG. 4, the drawing illustrates how an application (e.g., QuarkXpress) can map fields in the print document template 210 to the interactive application 310. The application used to create print document template 210 and the interactive application 310 can include functionality that allows the designer to create links 410 between the plurality of fields 420 in the print document template 210 and the data entry fields 430 in interactive application 310. These links then are used to map the data received from the end user via interactive application to the fields in print document template.

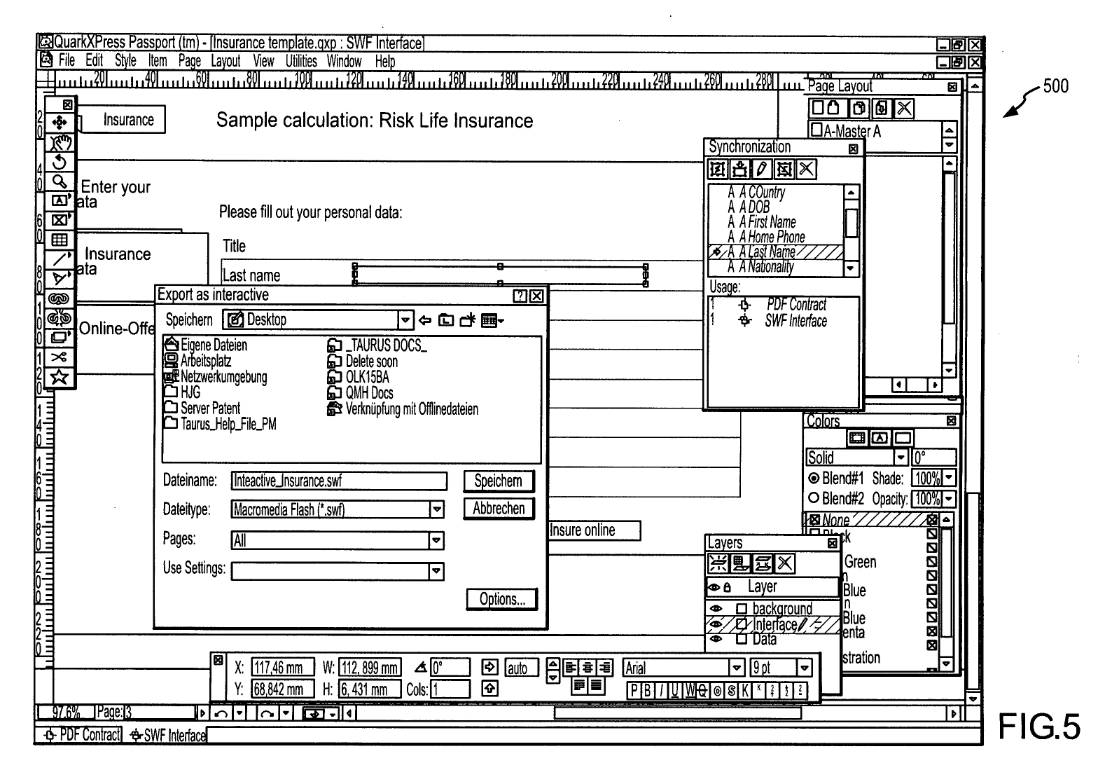

Referring now to FIG. 5, a screen shot 500 illustrates one embodiment of how an interactive application can be formatted and saved into specific application format. As discussed above, suitable application formats can include, but are not limited to, flash applications, java applets, extensible application mark-up language (XAML) applications, scalable vector graphics (SVG) applications, or the like.

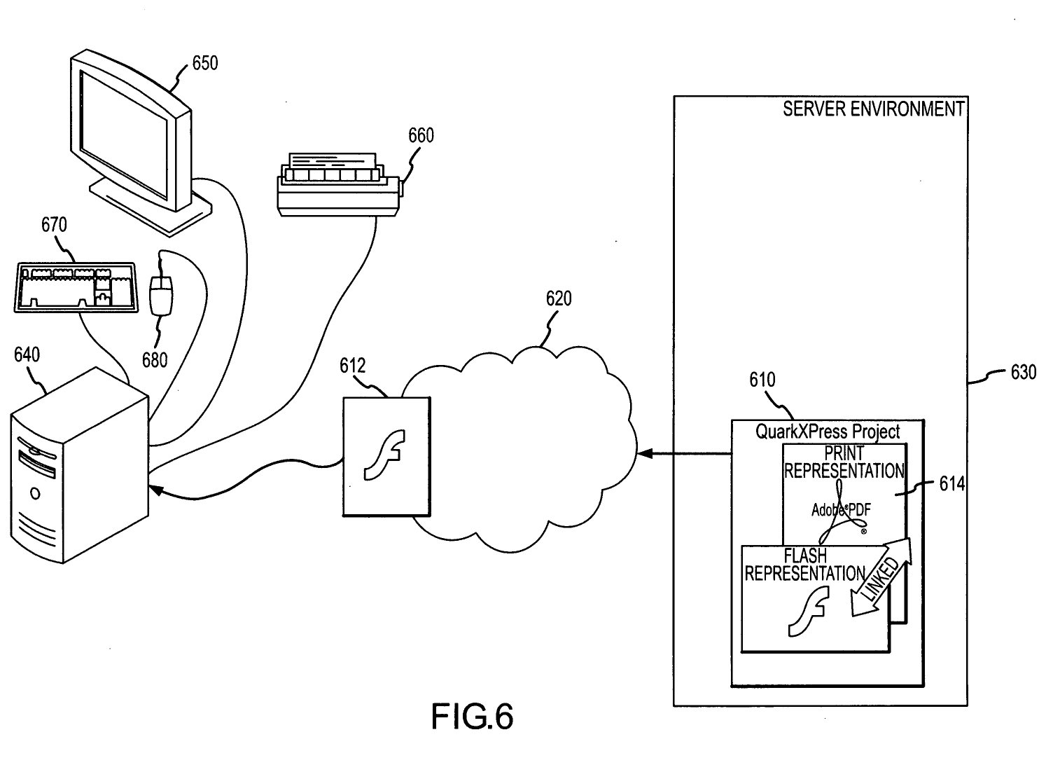

Referring now to FIGS. 6-13, one embodiment of a process that uses an interactive application to obtain data from an end user and populate a form or template will be discussed. After the printed document template 614 and the interactive application 612 have been created, they can be grouped into a project of application 610 (e.g., a QuarkXpress project) and saved up to a server 630. From server 630, the interactive application 612 can be transmitted to an end user computing device 640 via a network infrastructure 620, such as a company's intranet, the Internet, or some other suitable network configuration. FIG. 6 illustrates this process. As one skilled in the art will appreciate, end user computing device can be any suitable computing device currently known or hereinafter developed, such as a personal computer, as workstation, a handheld or portable computing device, or the like. In the embodiments illustrated in FIGS. 6-13, end user computing device 640 can include a display device 650, a printing device 660, and data entry devices, such as a keyboard 670 and a mouse 680. In addition, as one skilled in the art will appreciate, computing device 640 can include any other suitable peripheral device.

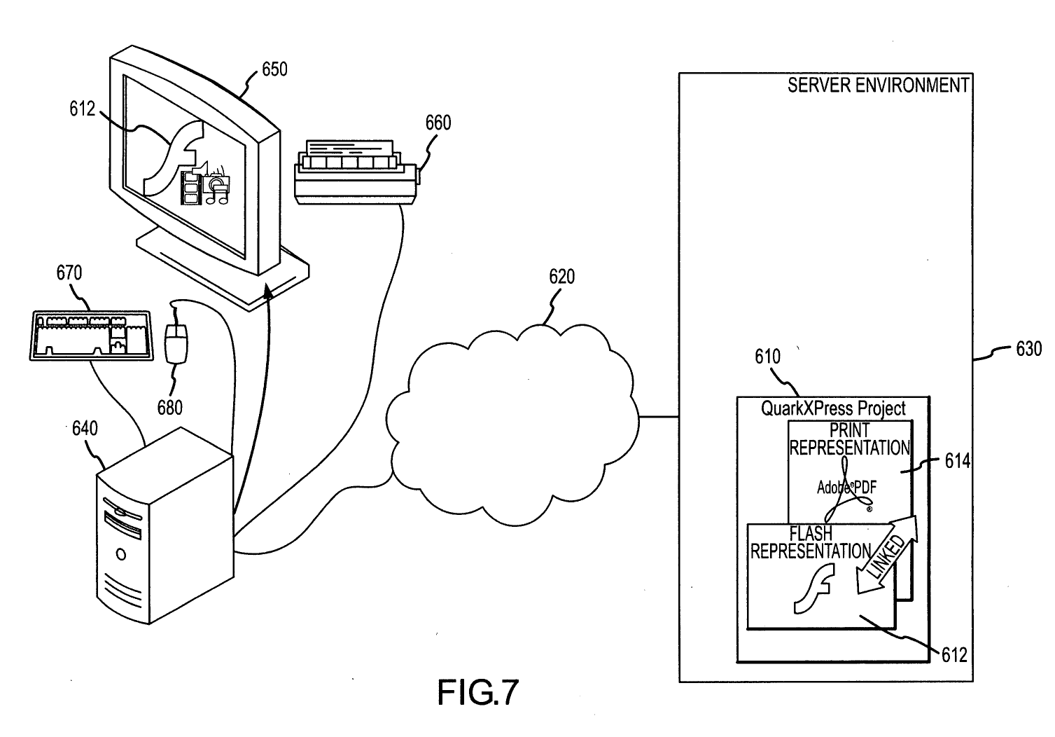

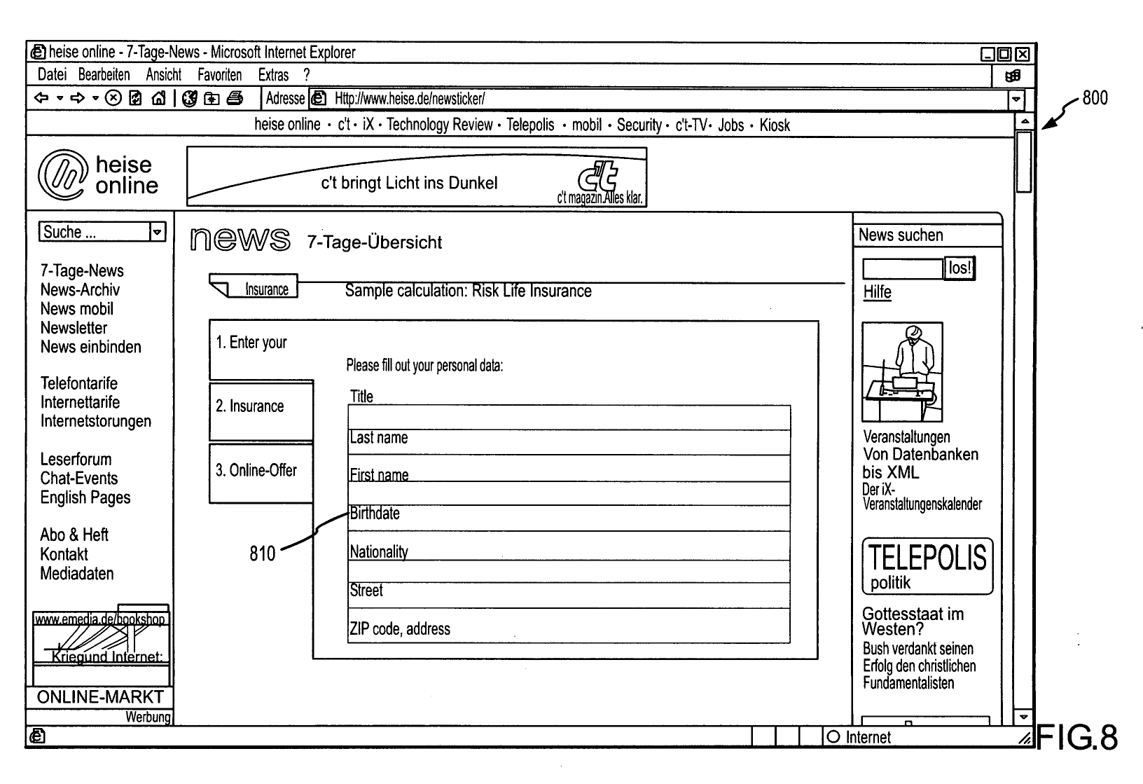

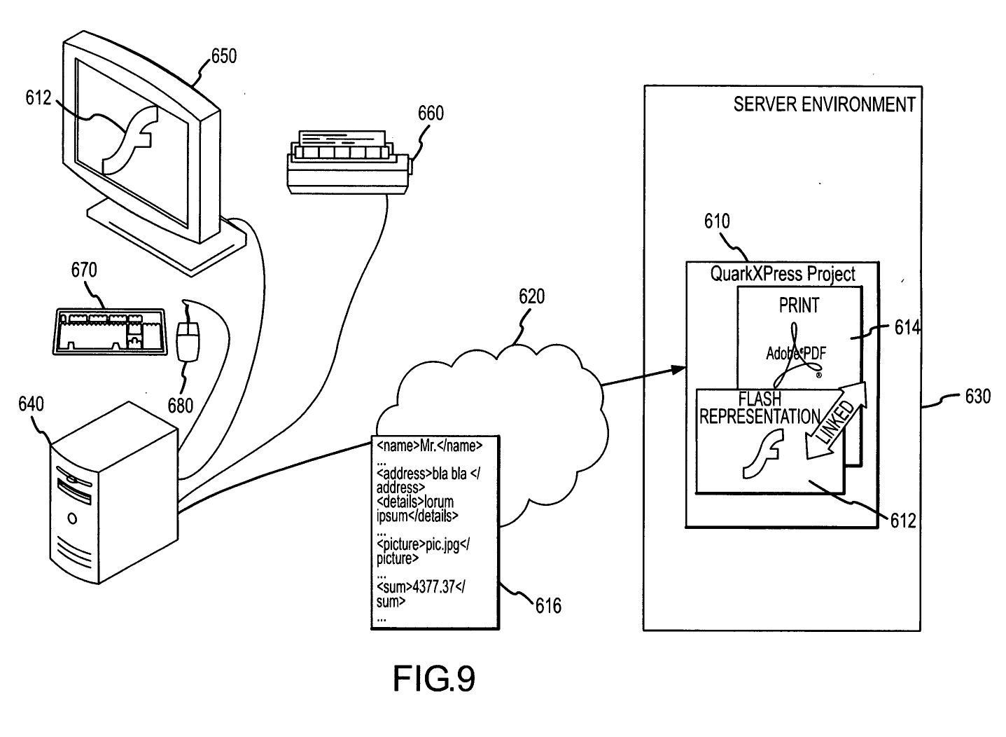

FIG. 7 illustrates interactive application 612 being displayed on an end user's display device or monitor 650. Further, FIG. 8 is a screen shot 800 illustrating one page or display of interactive application 612 as seen by an end user. Using the interactive application interface, the end user can enter the information requested by the interactive application in the appropriate fields 810. After the end user enters the information into the interactive application 612, the interactive application is operable to transmit the information back to the server 630, and application 610. In one embodiment, the end user entered information can be transmitted from end user computer 640 to server 630 via network 620 in extensible mark-up language (XML) format. This is illustrated in FIG. 9. As one skilled in the art will appreciate, while the illustrated embodiment shows data being transmitted in XML format, other suitable protocols can be used, such as, HTML, etc.

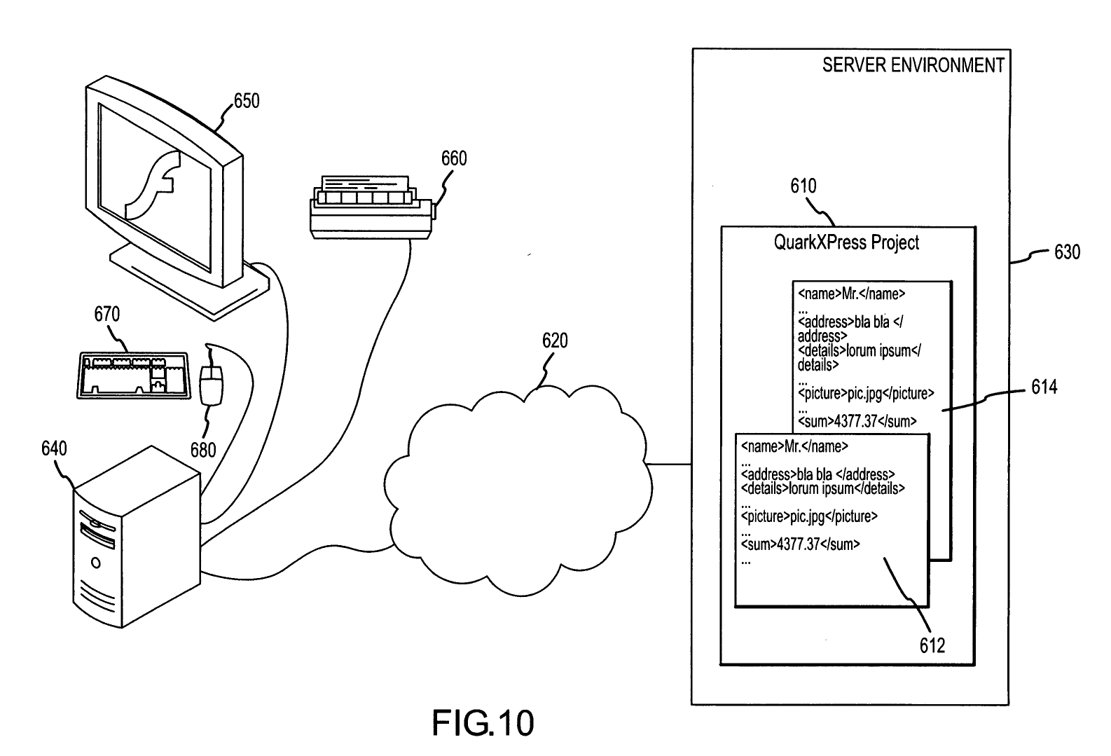

In server 630, application 610 is operable to take the end user entered data and populate it into print document 614. As discussed above, fields from the interactive application are mapped to fields in the print document. Thus, application 630 merely processes the mapping definition previously created. This is illustrated in FIG. 10. As discussed above, print document 614 can be any suitable print format document, such as a Microsoft™ Word™ document, an Adobe™ Portable Document Format (PDF) document, a postscript formatted document, or an SVG print document, or the like. In the illustrated embodiment, print document 614 is a PDF document.

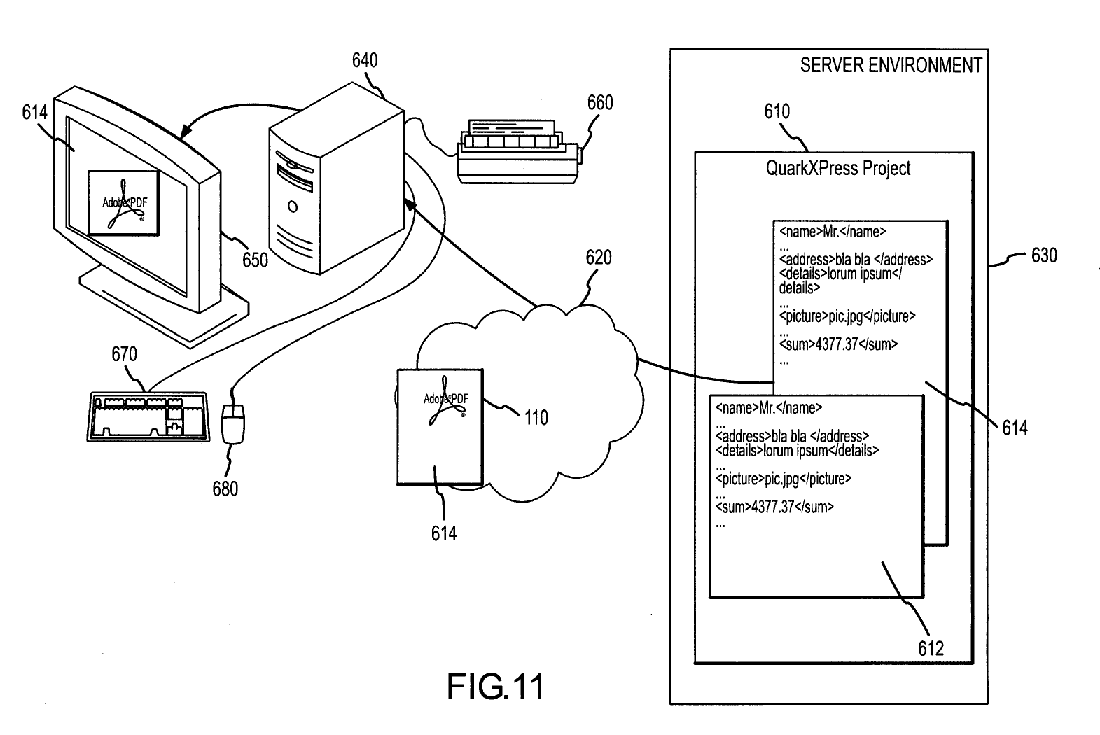

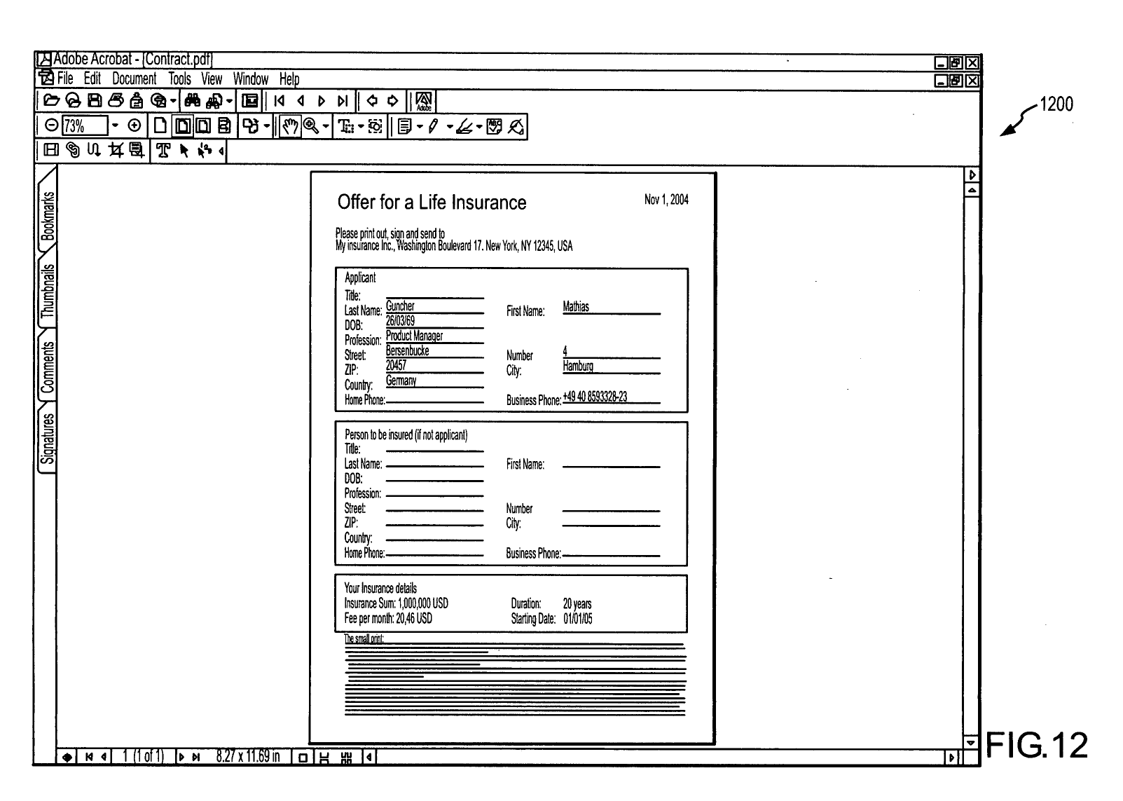

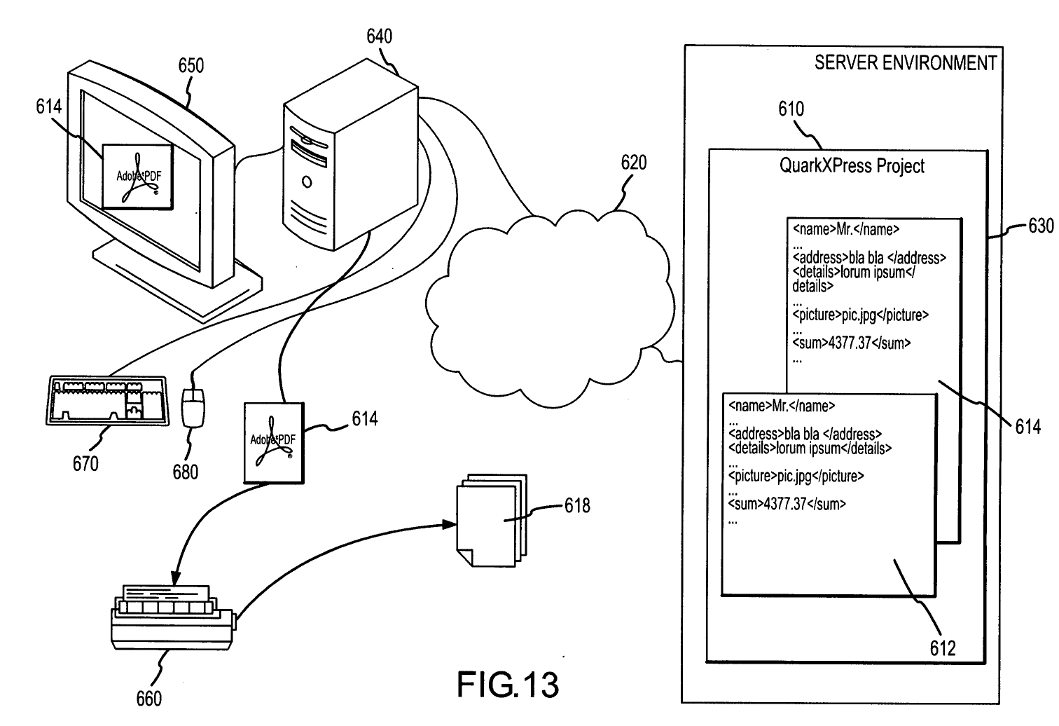

Once created, print document 614 can be transmitted to an end user computing device 640 via, for example, network 620. The end user computing device 640 then can display the print document on monitor 650 to ensure that it is correct. FIG. 11 illustrates this process. Further, FIG. 12 is a screen shot 1200 showing how the print document might look on monitor 650. As one can see, the print document is populated with the data entered via the interactive application. If the print document (e.g., a form, application, etc.) is accurate, the end user can print the document 618 using, for example, printer 660. This is illustrated in FIG. 13.

If the print document is not accurate for some reason, the end user can edit the document on end user computing device 640, or the end user can again request interactive application 612, which will allow the end user to correct the data using the interactive application. In this embodiment, once the data is corrected, server 630 can regenerate the print document and forward it to the end user for review and printing.

In conclusion, the present invention provides novel systems and methods for creating interactive applications and print document templates and using the interactive applications to obtain information from end users and populate the print document template with the data received from the end user. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for generating a document by collecting information from an end user using a multimedia interface, comprising:
at least one computing system comprising a processor and a computer readable medium, wherein the computer readable medium comprises instructions executable by the processor to:
receive instructions to create a print document template, which includes a plurality of fields to be populated by data received from an end user;
receive instructions to create an interactive application, the interactive application being operable to solicit and receive data from the end user, the data being mapable to the plurality of fields of the print document template;
forward the interactive application to the end user;
receive data from the end user via the interactive application; and
format the print document template with the data received from the end user.

2. The system as recited in claim 1, wherein the computer readable medium further comprises instructions executable by the processor to forward the print document template to the end user for printing.

3. The system as recited in claim 1, wherein the interactive application comprises an application selected from the group consisting of a flash application, a java applet, a extensible application mark-up language (XAML) application, and a scalable vector graphics (SVG) application.

4. The system as recited in claim 1, wherein the print document template comprises a document format selected from the group consisting of a Microsoft™ Word™ document, an Adobe™ Portable Document Format (PDF) document, a postscript formatted document, and a SVG print document.

5. The system as recited in claim 1, wherein the instructions executable by the processor to forward the interactive application to the end user comprise instructions to forward the entire interactive application to the end user prior to the end user running the interactive application.

6. The system as recited in claim 1, wherein the instructions executable by the processor to forward the interactive application to the end user comprises an end user computer pulling at least some of the interactive application instructions from the at least one computing system.

7. The system as recited in claim 1, wherein the instructions executable by the processor to receive data from the end user via the interactive application comprise instructions for receiving the data in extensible mark-up language (XML) format.

8. The system as recited in claim 1, wherein the at least one computing system comprises:
a first computing system operable to execute the instructions of:
receiving instructions to create a print document template; and
receiving instructions to create an interactive application; and
a second computing system operable to receive the print document template and the interactive application from the first computing system, and operable to execute the instructions of:
forwarding the interactive application to the end user;
receiving data from the end user via the interactive application; and
formatting the print document template with the data received from the end user.

9. A system for generating a document by collecting information from an end user using a multimedia interface, comprising:
a first computing system comprising a first processor and a first computer readable medium, wherein the first computer readable medium comprises instructions executable by the first processor to:
receive instructions to create a print document template, which includes a plurality of fields to be populated by data received from an end user; and
receive instructions to create an interactive application, the interactive application being operable to solicit and receive data from the end user, the data being mapable to the plurality of fields of the print document template; and
a second computing system in communication with the first computing system, the second computing system comprising a second processor and a second computer readable medium, the second computing system being operable to receive the print document template and the interactive application from the first computing system, and wherein the second computer readable medium comprises instructions executable by the second processor to:
forward the interactive application to the end user;
receive data from the end user via the interactive application; and
format the print document template with the data received from the end user.

10. The system as recited in claim 9, wherein the second computer readable medium further comprises instructions executable by the second processor to forward the print document template to the end user for printing.

11. The system as recited in claim 9, wherein the interactive application comprises an application selected from the group consisting of a flash application, a java applet, a extensible application mark-up language (XAML) application, and a scalable vector graphics (SVG) application.

12. The system as recited in claim 9, wherein the print document template comprises a document format selected from the group consisting of a Microsoft™ Word™ document, an Adobe™ Portable Document Format (PDF) document, a postscript formatted document, and a SVG print document.

13. The system as recited in claim 9, wherein the instructions executable by the second processor to forward the interactive application to the end user comprise instructions to forward the entire interactive application to the end user prior to the end user running the interactive application.

14. The system as recited in claim 9, wherein the instructions executable by the second processor to forward the interactive application to the end user comprises an end user computer pulling at least some of the interactive application instructions from the second computing system.

15. The system as recited in claim 9, wherein the instructions executable by the second processor to receive data from the end user via the interactive application comprise instructions for receiving the data in extensible mark-up language (XML) format.

16. A method for generating a document by collecting information from an end user using a multimedia interface, comprising:
creating a print document template, which includes a plurality of fields to be populated by data received from an end user;
creating an interactive application, the interactive application being operable to solicit and receive data from the end user, the data being mapable to the plurality of fields of the print document template;
forwarding the interactive application to the end user;
receiving data from the end user via the interactive application; and
formatting the print document template with the data received from the end user.

17. The method as recited in claim 16, further comprising:
forwarding the print document template to the end user for printing.

18. The method as recited in claim 16, wherein the interactive application comprises an application selected from the group consisting of a flash application, a java applet, a extensible application mark-up language (XAML) application, and a scalable vector graphics (SVG) application.

19. The method as recited in claim 16, wherein the print document template comprises a document format selected from the group consisting of a Microsoft™ Word™ document, an Adobe™ Portable Document Format (PDF) document, a postscript formatted document, and a SVG print document.

20. The method as recited in claim 16, wherein forwarding the interactive application to the end user comprises forwarding the entire interactive application to the end user prior to the end user running the interactive application.

21. The method as recited in claim 16, wherein forwarding the interactive application to the end user comprises an end user computer pulling at least some of the interactive application instructions from a server computing system.

22. The method as recited in claim 16, wherein receiving data from the end user via the interactive application comprises receiving the data in extensible mark-up language (XML) format.

23. The method as recited in claim 16, wherein:
the steps of creating a print document template and creating an interactive application are performed by a first computing system; and
the steps of forwarding the interactive application to the end user, receiving data from the end user via the interactive application, and formatting the print document template with the data received from the end user are performed by a second computing system.
